(19) United States
(12) Patent Application Publication
(10) Pub. No.: US 2012/0094173 A1
(43) Pub. Date: Apr. 19, 2012

(54) MACRO-POROUS GRAPHITE ELECTRODE MATERIAL, PROCESS FOR PRODUCTION THEREOF, AND LITHIUM ION SECONDARY BATTERY

(75) Inventors: Isamu Moruiguchi, Nagasaki (JP); Hirotoshi Yamada, Nagasaki (JP)

(73) Assignee: NAGASAKI UNIVERSITY, Nagasaki (JP)

(21) Appl. No.: 13/380,024

(22) PCT Filed: Jun. 24, 2010
(86) PCT No.: PCT/JP2010/060784

§ 371 Date: Dec. 21, 2011

(30) Foreign Application Priority Data
Jun. 25, 2009 (JP) 2009-151524

(51) Int. Cl. H01M 10/0525; H01M 10/056; H01M 4/04; H01M 4/66; H01M 4/70

(52) U.S. Cl. 429/188; 429/209; 264/29.1

(57) ABSTRACT

This invention provides a macroporous graphite electrode material that may be manufactured at a low temperature of 1500° C. or less and may be fast charged and discharged and a manufacturing method thereof. It also provides a lithium-ion secondary battery using this macroporous graphite electrode material.

The macroporous graphite electrode material according to this invention is composed of graphite having macropores in which a ratio of specific surface area of micropores in relation to total specific surface area is not less than 0 and not more than 0.74 and a ratio of D band area and G band area in Raman spectrum (D/G area ratio) is not less than 0 and not more than 1.33.

### TECHNICAL FIELD

This invention relates to, principally, a macroporous graphite electrode material to be used as a negative electrode active material of a lithium-ion secondary battery, a manufacturing method thereof and the lithium-ion secondary battery.

### BACKGROUND TECHNOLOGY

Since a lithium-ion secondary battery has a high energy density, it has widely utilized as power source for small-sized electronic equipment such as a portable phone or a notebook computer. It is recently desired to allow the battery to output higher power in order to apply it to a power source for electric auto vehicle. Although graphite is mainly used as a negative electrode material for the currently used lithium-ion secondary battery, further improvement is necessary to aim at the higher power output.

As a method of obtaining the graphite artificially, a method of performing a heat treatment on a soft carbon raw material such as pitch at more than 2500° C. has been commonly used, in which energy consumption has been large. A method of obtaining it at a relatively low temperature based on a reaction of catalyst and carbon has been recently developed (see Patent Document 1 and Patent Document 2).

### PRIOR ARTS

### Patent Documents

Patent Document 1: Japanese Patent Application Publication No. 2008-66503
Patent Document 2: WO2006/118120(Japanese Patent Application Publication No. 2007-514751)

### DISCLOSURE OF THE INVENTION

### Problem(s) to be Solved by the Invention

In view of the above-mentioned points, this invention provides a macroporous graphite electrode material that may be manufactured at a low temperature of 1500° C. or less and may be fast charged and discharged and a manufacturing method thereof. Further, it also provides a lithium-ion secondary battery using this macroporous graphite electrode material.

### Means for Solving the Problem(s)

In order to solve the above-mentioned problem and satisfy the object of this invention, a macroporous graphite electrode material according to this invention is graphitized at a heat treatment temperature of 1500° C. or less and is composed of macroporous material in which the macropores have a porous structure in which macropores are three-dimensionally connected to each other and walls of the macropores are composed of graphitized carbon. Further, a ratio of specific surface area of micropores in relation to total specific surface area is not less than 0 and not more than 0.74 and a ratio of D band area and G band area in Raman spectrum (D/G area ratio) is not less than 0 and not more than 1.33. Here, the macropore is referred to as a pore having a diameter of 50 nm or more and the micropore is referred to as a pore having a diameter of 2 nm or less.

By the macroporous graphite electrode material according to the invention, it is possible to improve a charge-discharge capacity and realize a fast charge and discharge.

Further, a manufacturing method of the macroporous graphite electrode material according to the invention contains following steps: first, a step of preparing a mold made of SiO₂ particles; a step of mingling the mold with a solution for carbon source; a step of resinifying the carbon source to form a composite of a carbon precursor resin and the mold; a step of removing the mold therefrom to form macroporous carbon; and a step of supporting catalyst on the macroporous carbon. It also contains a step of forming a macroporous graphite by performing a heat treatment on the macroporous carbon supporting the catalyst at a temperature of not less than 900° C. and not more than 1500° C. so as to be graphitized.

Here, the carbon precursor resin is referred to as a situation where the carbon source is polymerized so as to become polymer solid.

Further, a manufacturing method of the macroporous graphite electrode material according to the invention contains following steps: first, a step of preparing a mold made of SiO₂ particles; a step of preparing a solution for carbon source into which a catalyst is added; a step of mingling the mold with the solution for carbon source; and a step of resinifying the carbon source to form a composite of a carbon precursor resin and the mold. It also contains a step of forming a composite of a graphite and the mold by performing a heat treatment on the composite of the carbon precursor resin and the mold at a heat treatment temperature of not less than 900° C. and not more than 1500° C. so as to be graphitized; and a step of removing the mold and the catalyst from the composite of the graphite and the mold.

By the manufacturing methods of the macroporous graphite electrode material according to the invention, it is possible to realize the graphitization at some low heat treatment temperature of not less than 900° C. and not more than 1500° C. based on an effect of the catalyst so that reduction in energy when manufacturing it is satisfied. An improvement of the charge-discharge capacity is also satisfied and a fast chargeable and dischargeable macroporous graphite electrode material is obtained.

Additionally, a lithium-ion secondary battery according to the invention is composed of a positive electrode element, a negative electrode element and a nonaqueous electrolyte. The positive electrode element contains, as a positive electrode active material, a lithium-transition metal composite compound into or from which lithium ions can be reversibly adsorbed or discharged. The negative electrode element is also composed of the above-mentioned macroporous graphite electrode material according to the invention and contains a negative electrode active material which adsorbs or discharges the lithium ions at lower electric potential than that of the positive electrode active material. The nonaqueous electrolyte also has a composition such that lithium salts are dissolved in a nonaqueous solvent solution.

### Effect of the Invention

According to the invention, it is possible to obtain the macroporous graphite electrode material which is capable of reducing the energy when manufacturing it and realizing the fast charge and discharge and the lithium-ion secondary battery.

### BRIEF DESCRIPTION OF DRAWINGS

FIGS. 1A through 1H are diagrams showing a manufacturing method of a macroporous graphite electrode material (No. 1) according to a first embodiment of this invention.

FIGS. 2A through 2E are diagrams showing a manufacturing method of a macroporous graphite electrode material (No. 2) according to a first embodiment of this invention.

FIG. 3 is X-ray diffraction (XRD) patterns of specimens 1, 2 and 3.

FIG. 4 is X-ray diffraction patterns of specimens 1, 4 and 5.

FIG. 5 is X-ray diffraction patterns of specimens 14 and 17.

FIG. 6 is X-ray diffraction patterns of specimens 6, 7, 8 and 19.

FIG. 7 is X-ray diffraction patterns of specimens 7 through 13.

FIG. 8 is X-ray diffraction patterns of specimens 7, 11, 12 and 13.

FIG. 9 is a photograph of the macroporous carbon by a transmission electron microscope (TEM), which is obtained by removing SiO₂ opal, which is a mold, after a heat treatment has been performed on a composite of a carbon precursor resin and SiO₂ opal composed of SiO₂ particles having mean particle size of 190 nm at a temperature of 400° C. when manufacturing the specimen 1 in execution examples 1.

FIGS. 10A and 10B are a TEM photograph of the specimen 4 made by graphitizing it at a treatment temperature of 1000° C. and a TEM photograph in which a part the specimen 4 is enlarged.

FIG. 11 is a TEM photograph of the macroporous carbon which is obtained by removing the mold after a heat treatment has been performed on a composite of carbon resin and the mold composed of SiO₂ particles having mean particle size of 450 nm at a temperature of 400° C. when manufacturing the specimen 6 using the execution examples 1.

FIGS. 12A and 12B are a TEM photograph of the specimen 6 made by graphitizing it at a treatment temperature of 1000° C. and a TEM photograph in which a part of the specimen 6 (a part of pore wall) is enlarged.

FIGS. 13A and 13B are a TEM photograph of the specimen 12 made by graphitizing it at a treatment temperature of 1400° C. using a mold composed of SiO₂ particles having mean particle size of 450 nm and a TEM photograph in which a part (a part of pore wall) is enlarged.

FIG. 14 shows Raman spectra of the specimens 4 and 18.

FIG. 15 shows Raman spectra of the specimens 2 and 3.

FIG. 16 shows Raman spectra of the specimens 6, 7, 8 and 19.

FIG. 17 is a diagram showing charge and discharge curves of the specimen 2 made by the execution examples 1.

FIG. 18 is a diagram showing charge and discharge curves of the specimen 3 made by the execution examples 1.

FIG. 19 is a diagram showing charge and discharge curves of the specimen 4 made by the execution examples 1.

FIG. 20 is a diagram showing charge and discharge curves of the specimen 5 made by the execution examples 1.

FIG. 21 is a diagram showing charge and discharge curves of the specimen 6 made by the execution examples 1.

FIG. 22 is a diagram showing charge and discharge curves of the specimen 7 made by the execution examples 1.

FIG. 23 is a diagram showing charge and discharge curves of the specimen 17 made by a comparison example.

FIG. 24 is a diagram showing charge and discharge curves of the specimens 4, 14, 15, 16 and 18 on current density of 37.2 mA/g.

FIG. 25 is a diagram showing charge and discharge curves of the specimens 10, 12, 13, 19 and 20 on current density of 37.2 mA/g.

FIG. 26 shows rate performances of the specimens 4, 6, 7, 14 and 15 and artificial graphite.

FIG. 27 shows rate performances of the specimens 4, 6, 7, 14 and 15 and artificial graphite.

FIG. 28 shows rate performances (discharge capacity up to 3V) of the specimens 11, 12, 13 and 20 and artificial graphite.

FIG. 29 shows rate performances (discharge capacity up to 0.5V) of the specimens 11, 12, 13 and 20 and artificial graphite.

FIG. 30 shows rate performances (discharge capacity up to 3V) of the specimens 3, 4, 5 and 20.

FIG. 31 shows rate performances (discharge capacity up to 0.5V) of the specimens 3, 4, 5 and 20.

FIG. 32 is a diagram showing cycle life characteristic of the specimen 11 on current density of 37.2 mA/g.

FIG. 33 is a diagram showing an outline configuration of a lithium-ion secondary battery according to a second embodiment of this invention.

### EMBODIMENTS FOR CARRYING OUT THE INVENTION

### First Embodiment

### Macroporous Graphite Electrode Material

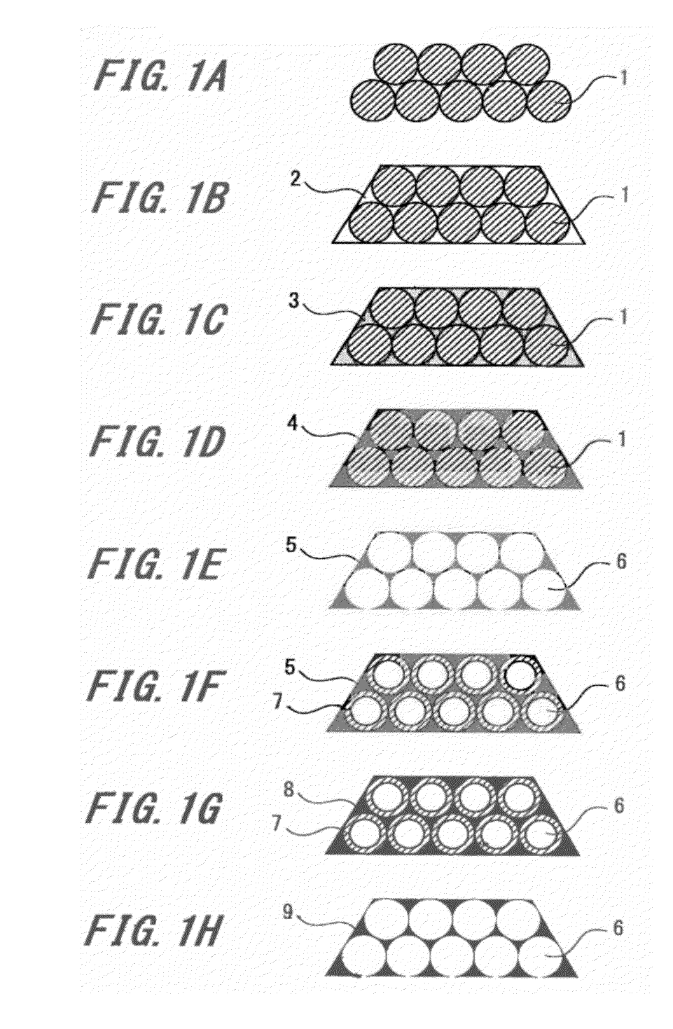

The following will describe a macroporous graphite electrode material and a manufacturing method thereof with reference to FIGS. 1A through 1H.

(Configuration of Macroporous Graphite Electrode Material)

First, the following will describe a configuration of the macroporous graphite electrode material according to this embodiment and its characteristics thereof. The macroporous graphite electrode material according to this embodiment is composed of macroporous material in which macropores have a porous structure such that macropores are three-dimensionally connected with each other and walls of the macropores thereof are composed of graphitized carbon. A total specific surface area thereof is also 69 m²g⁻¹ or more and a ratio of specific surface area of micropores in relation to total specific surface area is not less than 0 and not more than 0.74 and a ratio of D band area and G band area in Raman spectrum (D/G area ratio) is not less than 0 and not more than 1.33.

Here, the micropore is referred to as a pore having diameter of not more than 2 nm.

When advancing the graphitization, the ration of the specific surface area of micropores in relation to the total specific surface area decreases. In this embodiment, it is preferred that the graphitization is advanced so that the ratio of the specific surface area of micropores in relation to the total specific surface area is not more than 0.74. The D/G area ratio also indicates an advanced degree of the graphitization. Thus, if the D/G area ratio is more than 1.33, the graphitization is inadequate so that any good conductivity cannot be given and any charge-and-discharge capacity in a low electric potential cannot be given. Therefore, it is preferred that D/G area ratio is not less than 0 and not more than 1.33.

[Manufacturing Method (No. 1) of Macroporous Graphite Electrode Material]

Next, the following will describe a manufacturing method of macroporous graphite electrode material according to this embodiment with reference to FIGS. 1A through 1H.

First, by centrifuging colloidal solution which contains silicon oxide (SiO₂) having mean particle size of not less than 100 nm and not more than 450 nm and decompressing and drying it, as shown in FIG. 1A, SiO₂ particles aggregation (hereinafter, referred to as “SiO₂ opal 1”) composed of SiO₂ particles having mean particle size of not less than 100 nm and not more than 450 nm is obtained. This SiO₂ opal 1 is a mold in this embodiment and is composed of aggregation of plural SiO₂ particles.

On the other hand, by preparing a mixed solution mixing phenol with formaldehyde so that their mol ratio is 1:0.85 and adding hydrochloric acid to this mixed solution by a little amount thereof, a solution for carbon source is prepared.

Next, as shown in FIG. 1B, the dried SiO₂ opal 1 is dipped into the solution for carbon source 2 for 12 hours. The SiO₂ opal 1 dipped into the solution for carbon source 2 is then filtered and is heated at 128° C. for 12 hours to remove moisture or the like therefrom and resinify the carbon source, thereby preparing composite 3 of, as shown in FIG. 1C, phenol resin and SiO₂ particles 1.

Here, the phenol resin corresponds to carbon precursor resin according to this invention.

Next, by performing heat treatment on the composite 3 of the phenol resin and SiO₂ opal 1 in argon atmosphere at 400° C. for 5 hours, the phenol resin is carbonized to obtain composite 4, as shown in FIG. 1D, of carbon and SiO₂ opal 1.

Next, by wet-etching using hydrogen fluoride (HF) solution, as shown in FIG. 1E, SiO₂ opal 1 is removed. This allows pores 6 to be formed in positions from which SiO₂ opal 1 that is the mold is removed so that a macroporous carbon 5 is formed.

The macroporous carbon 5 is then dipped into a methanol solution of nickel nitrate (II) for one hour. It is preferred that a concentration of the nickel nitrate is not less than 3 mmol and not more than 15 mmol in relation to the macroporous carbon of 1 gram. The macroporous carbon is then dried at 100° C. so that as shown in FIG. 1F, the macroporous carbon 5 supporting nickel nitrate 7 is adjusted. This nickel nitrate 7 is used as catalyst and is removed at a following step.

The macroporous carbon 5 supporting the nickel nitrate 7 is then heated in the argon atmosphere for three hours so that the macroporous carbon 5 is graphitized, thereby obtaining a graphitized porous carbon 8 as shown in FIG. 1G. In this moment, a heat treatment temperature Tc is set within a range of 900° C.<=Tc<=1500° C. In this embodiment, as the macroporous carbon 5 supports the nickel nitrate 7 as the catalyst, the macroporous carbon 5 is graphitized at the heat treatment temperature within a range of 900° C.<=Tc<=1500° C.

For example, hydrochloric acid of 10% then dissolves the nickel nitrate 7 which is the catalyst supported by the graphitized porous carbon 8. This enables macroporous graphite electrode material 9 to be completed in which the macropores have a porous structure in which the macropores are three-dimensionally connected to each other and the walls of the pores are composed of graphitized carbon.

In this embodiment, the pores 6 has been formed by using the mold (SiO₂ opal 1) composed of SiO₂ particles, but it is possible to control a diameter of each of the pores 6 in the finally obtained macroporous graphite electrode material 9 based on a size of the particle to be used as the mold, whereby controlling the specific surface area. Here, a size of each of the particles is referred to as a size of one SiO₂ particle. Namely, the mold for one pore is SiO₂ particle and the mold for whole of the porous structure is SiO₂ opal. In this embodiment, it is possible to adjust the specific surface area optimally by adjusting mean particle size of the SiO₂ particles constituting SiO₂ opal 1 so as to be not less than 100 nm and not more than 450 nm.

Further, although, in this embodiment, as shown in FIG. 1D, a step of carbonizing the phenol resin has been described, this carbonizing step may be omitted. If the carbonizing step is omitted, the carbonization and graphitization are advanced at the same time or one by one in the next heating step. In this case, it is possible to set the heat treatment temperature of the graphitization, based on an effect of the catalyst, within a range of 900° C.<=Tc<=1500° C.

[Manufacturing Method (No. 2) of Macroporous Graphite Electrode Material]

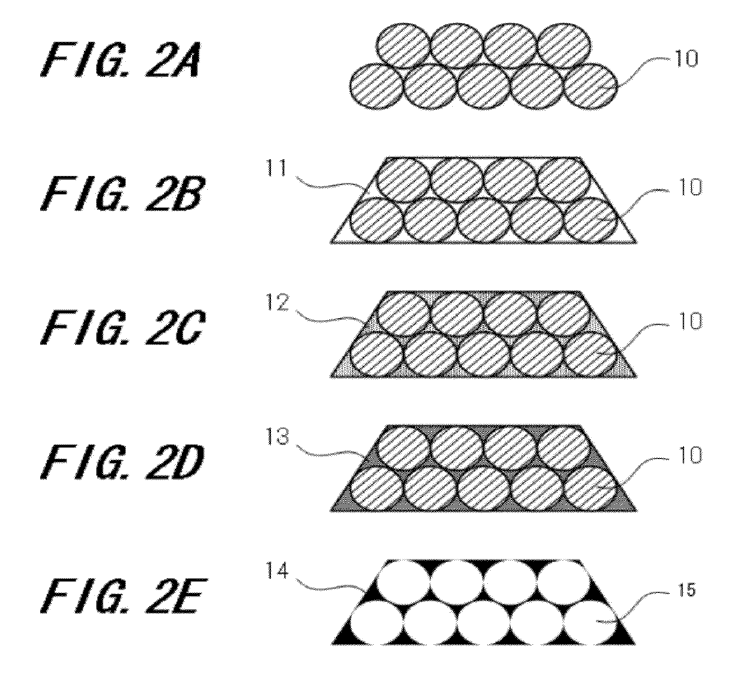

Next, the following will describe another example of manufacturing method of macroporous graphite electrode material according to this embodiment with reference to FIGS. 2A through 2E.

First, by centrifuging colloidal solution which contains silicon oxide (SiO₂) having mean particle size of not less than 100 nm and not more than 450 nm and decompressing and drying it, as shown in FIG. 2A, SiO₂ opal 10 composed of SiO₂ particles, which is a mold, is obtained.

On the other hand, by preparing a mixed solution mixing phenol with formaldehyde so that their mol ratio is 1:0.85, adding hydrochloric acid to this mixed solution by a little amount thereof and adding nickel nitrate which becomes a catalyst so as to become a predetermined concentration thereof, a solution for carbon source containing the catalyst is prepared. The concentration of this nickel nitrate is set so that the nickel nitrate becomes not less than 3 mmol/g^{-C} and 15 mmol/g^{-C} when, in the following step, baking the carbon source.

Next, as shown in FIG. 2B, the dried SiO₂ opal 10 is dipped into the solution for carbon source 11 for 12 hours. The SiO₂ opal 10 dipped into the solution for carbon source 11 is then filtered and is heated at 128° C. for 12 hour to remove moisture or the like therefrom and resinify the carbon source, thereby preparing composite 12 of, as shown in FIG. 2C, phenol resin, the SiO₂ opal 10 and the nickel nitrate.

Further, the composite 12 of the phenol resin, the SiO₂ opal 10 and the nickel nitrate is heated in argon atmosphere for 3 hours so that the phenol resin is carbonized and graphitized at the same time to obtain composite 13, as shown in FIG. 2D, of graphitized carbon, SiO₂ opal 10 and the nickel nitrate. In this moment, a heat treatment temperature Tc is set within a range of 900° C.<=Tc<=1500° C. In this embodiment, as the nickel nitrate, to become the catalyst, is contained in the solution for the carbon source, the phenol resin is carbonized and graphitized at the same time at the heat treatment temperature within a range of 900° C.<=Tc<=1500° C.

By wet-etching using HF solution, SiO₂ opal 10 is removed and Ni is removed. This allows pores 15 to be formed in positions from which SiO₂ opal 10 which is the mold is removed so that macroporous graphite electrode material 14 is completed.

Also, in this embodiment, the pores 15 have been formed using the mold (SiO₂ opal 10) composed of SiO₂ particles, but it is possible to control a diameter of each of the pores 15 in the finally obtained macroporous graphite electrode material 14 based on a size of the particle to be used as the mold, thereby controlling the specific surface area. In this embodiment, the specific surface area may be optimally adjusted by adjusting SiO₂ opal 10, to become the mold, so as to be within a range of 100 nm through 450 nm.

Since, in the above-mentioned manufacturing method (No. 1 and No. 2), the total specific surface area, the ratio of specific surface area of the micropores in relation to the total specific surface area and the D/G area ratio are preferably formed, macroporous graphite electrode material having an excellent charge-discharge behavior can be obtained. Further, the above-mentioned manufacturing method (No. 2) may decrease numbers of steps when comparing the manufacturing method (No. 1) because the catalyst has previously mixed into the carbon source.

Although, in the above-mentioned manufacturing method (No. 1 and No. 2), an example in which phenol/formaldehyde are used as the carbon source has been described, others such as resorcinol/formaldehyde, furfuryl alcohol, polyimid, pitch or the like may be used. Further, although an example in which, in the above-mentioned manufacturing method (No. 1 and No. 2), the nickel nitrate has been used as the catalyst has been described, others such as metal salt (a nitrate, an acetate or a chloride) of nickel, iron or cobalt or a complex (acelacetone complex or the like) may be applied. In this embodiment, a heat treatment temperature which is necessary for graphitization may be set to a relative low temperature of 900° C.<=Tc<=1500 based on an effect of the catalyst.

The following will describe the macroporous graphite electrode material according to this invention more in detail by showing execution examples and comparison example, but this invention is not limited to the following execution examples.

### Execution Examples 1

In the execution examples 1, specimens of the macroporous graphite electrode material were made using the above-mentioned manufacturing method (No. 1).

First, by centrifuging colloidal solution which contains silicon oxide (SiO₂) having mean particle size of 190 nm and decompressing and drying it, SiO₂ opal composed of SiO₂ particles, which became the mold, was made.

On the other hand, by preparing a mixed solution mixing phenol with formaldehyde so that their mol ratio is 1:0.85 and adding hydrochloric acid to this mixed solution by a little amount thereof, a solution for carbon source was prepared.

Next, the dried SiO₂ opal was dipped into the carbon source for 12 hours. The SiO₂ opal dipped into the solution for carbon source was then filtered and was heated at 128° C. for 12 hours to remove moisture or the like therefrom and resinify the carbon source, thereby preparing composite of phenol resin and SiO₂ particles.

Next, by performing heat treatment on the composite of the phenol resin and SiO₂ opal in argon atmosphere at 400° C. for 5 hours, the composite of carbon and SiO₂ opal was obtained.

Next, by wet-etching using HF solution, SiO₂ opal was removed to obtain the macroporous carbon.

The macroporous carbon was then dipped into a methanol solution of nickel nitrate (II) for one hour. A concentration of the nickel nitrate was set to 3 mmol in relation to the macroporous carbon of 1 gram. The macroporous carbon was then dried at 100° C. so that the macroporous carbon supporting the nickel nitrate was adjusted.

The macroporous carbon supporting the nickel nitrate was then heated at 900° C. in the argon atmosphere for three hours so that the macroporous carbon was graphitized, thereby obtaining a macroporous graphite.

Hydrochloric acid of 10% concentration then dissolved the nickel nitrate which is a catalyst supported by the graphitized porous carbon so that the specimen 1 was obtained.

Further, in the above-mentioned execution examples 1, by setting the concentration of the nickel nitrate to 9 mmol in relation to the macroporous carbon of 1 gram and setting the heat treatment temperature for graphitization to 900° C., the specimen 2 was obtained.

Further, in the above-mentioned execution examples 1, by setting the concentration of the nickel nitrate to 15 mmol in relation to the macroporous carbon of 1 gram and setting the heat treatment temperature for graphitization to 900° C., the specimen 3 was obtained.

Further, in the above-mentioned execution examples 1, by setting the heat treatment temperature for graphitization to 1000° C., the specimen 4 was obtained.

Further, in the above-mentioned execution examples 1, by setting the heat treatment temperature for graphitization to 1500° C., the specimen 5 was obtained.

Further, in the above-mentioned execution examples 1, by using SiO₂ particles having mean particle size of 450 nm as SiO₂ particles constituting the SiO₂ opal, which was a mold, and setting the heat treatment temperature for graphitization to 1000° C., the specimen 6 was obtained.

Further, in the above-mentioned execution examples 1, by using SiO₂ opal composed of SiO₂ particles having mean particle size of 450 nm as the mold, setting the concentration of the nickel nitrate to 15 mmol in relation to the

macroporous carbon of 1 gram and setting the heat treatment temperature for graphitization to 1000° C., the specimen 7 was obtained.

Further, in the above-mentioned execution examples 1, by using SiO₂ particles having mean particle size of 450 nm as particles constituting the mold and setting the concentration of the nickel nitrate to 15 mmol in relation to the macroporous carbon of 1 gram, the specimen 8 was obtained.

Further, in the above-mentioned execution examples 1, by using SiO₂ particles having mean particle size of 450 nm as particles constituting the mold, setting the concentration of the nickel nitrate to 15 mmol in relation to the macroporous carbon of 1 gram and setting the heat treatment temperature for graphitization to 1100° C., the specimen 9 was obtained.

Further, in the above-mentioned execution examples 1, by using SiO₂ particles having mean particle size of 450 nm as particles constituting the mold, setting the concentration of the nickel nitrate to 15 mmol in relation to the macroporous carbon of 1 gram and setting the heat treatment temperature for graphitization to 1200° C., the specimen 10 was obtained.

Further, in the above-mentioned execution examples 1, by using SiO₂ particles having mean particle size of 450 nm as particles constituting the mold, setting the concentration of the nickel nitrate to 15 mmol in relation to the macroporous carbon of 1 gram and setting the heat treatment temperature for graphitization to 1300° C., the specimen 11 was obtained.

Further, in the above-mentioned execution examples 1, by using SiO₂ particles having mean particle size of 450 nm as particles constituting the mold, setting the concentration of the nickel nitrate to 15 mmol in relation to the macroporous carbon of 1 gram and setting the heat treatment temperature for graphitization to 1400° C., the specimen 12 was obtained.

Further, in the above-mentioned execution examples 1, by using SiO₂ particles having mean particle size of 450 nm as particles constituting the mold, setting the concentration of the nickel nitrate to 15 mmol in relation to the macroporous carbon of 1 gram and setting the heat treatment temperature for graphitization to 1500° C., the specimen 14 was obtained.

### Execution Example 2

In the execution example 2, a specimen of the macroporous graphite electrode material was made using the above-mentioned manufacturing method (No. 2).

First, by centrifuging colloidal solution which contains silicon oxide (SiO₂) having mean particle size of 190 nm and decompressing and drying it, SiO₂ opal composed of SiO₂ particles, which became a mold, was made.

On the other hand, by preparing a mixed solution mixing phenol of 6.5 grams with formaldehyde of 4.8 grams, adding hydrochloric acid to this mixed solution by a little amount thereof and adding the nickel nitrate of 2.96 grams, which became the catalyst, a solution for carbon source which contains the catalyst was prepared.

Next, the dried SiO₂ opal was dipped into the solution for carbon source containing the catalyst for 12 hours. The SiO₂ opal dipped into the solution for carbon source containing the catalyst was then filtered and was heated at 128° C. for 12 hours to remove moisture or the like therefrom and resinify the carbon source, thereby preparing composite of phenol resin, the SiO₂ opal and the nickel nitrate.

Next, the composite of the phenol resin, the SiO₂ opal and the nickel nitrate was heated in argon atmosphere at 900° C. for 3 hours so that the phenol resin was carbonized and graphitized at the same time to obtain the graphited porous carbon.

By the wet-etching using HF solution, SiO₂ particles were then removed and Ni was removed so that the specimen 14 was obtained.

### Comparison Examples

In the comparison examples, first, SiO₂ opal, formed similar to that of the execution examples 1, which was composed of SiO₂ particles having mean particle size of 190 nm was introduced into a solution for carbon source which was composed of pitch and quinoline and the composite of the solution for carbon source and SiO₂ opal was heated at 1000° C. in the argon atmosphere for 5 hours, thereby carbonizing the pitch. This enables the composite of the carbon and SiO₂ opal to be formed. Next, by wet etching using HF solution, SiO₂ opal was removed from the composite of the carbon and SiO₂ opal to obtain the macroporous carbon. The macroporous carbon was then heated at 2500° C. in the argon atmosphere for 0.5 hours so that the macroporous carbon was graphitized to obtain a specimen 15.

Namely, the comparison examples are examples in which the macroporous carbon was graphitized without supporting any catalyst.

A specimen 16 (macroporous carbon) was obtained without performing any heat treatment at 2500° C. in the above-mentioned comparison example.

Further, in the above-mentioned comparison example, by using mixed solution composed of phenol, formaldehyde and a small amount of hydrochloric acid as the solution for carbon source and setting a heat treatment temperature in a carbonizing step to 900° C. without any heating treatment at 2500° C., a specimen 17 was obtained.

Further, in the above-mentioned comparison example, by using mixed solution composed of phenol, formaldehyde and a small amount of hydrochloric acid as the solution for carbon source and setting a heat treatment temperature in a carbonizing step to 1000° C. without any heating treatment at 2500° C., a specimen 18 was obtained.

Further, in the above-mentioned comparison example, by using mixed solution composed of phenol, formaldehyde and a small amount of hydrochloric acid as the solution for carbon source, and using SiO₂ opal as the mold, which was composed of SiO₂ particles having mean particle size of 450 nm and setting a heat treatment temperature in a carbonizing step to 1000° C. without performing any heat treatment at 2500° C., a specimen 19 was obtained.

Further, in the above-mentioned comparison example, by using SiO₂ opal as the mold, which was composed of SiO₂ particles having mean particle size of 450 nm, a specimen 20 was obtained.

### [Estimations of Execution Examples and Comparison Examples]

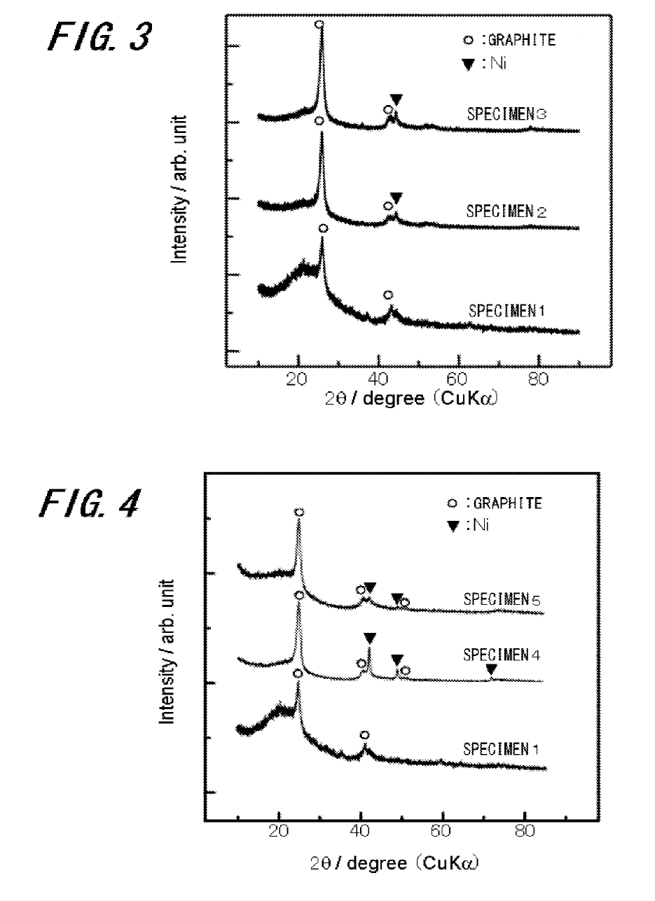

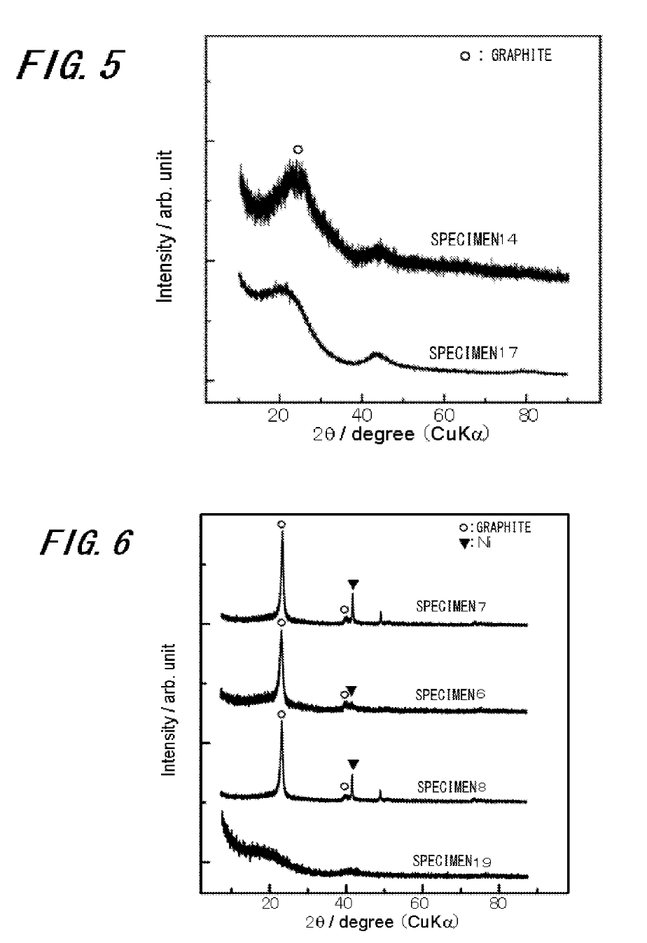

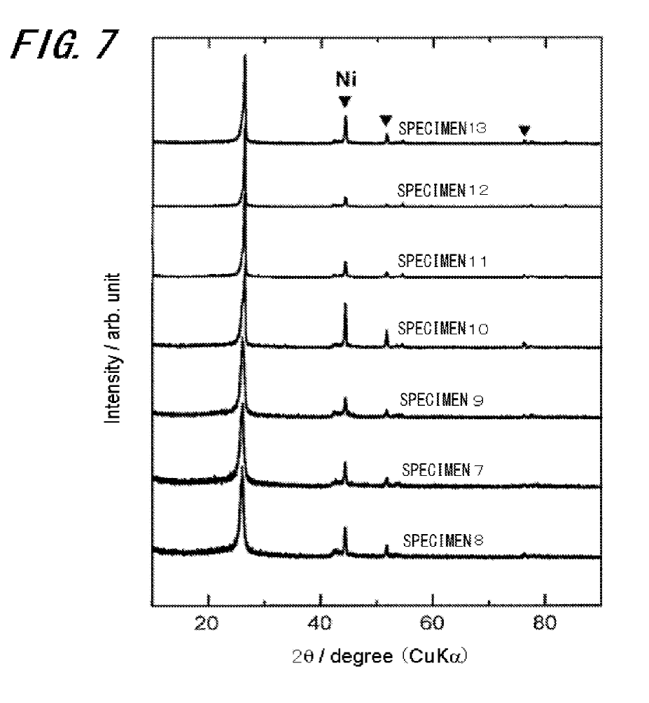

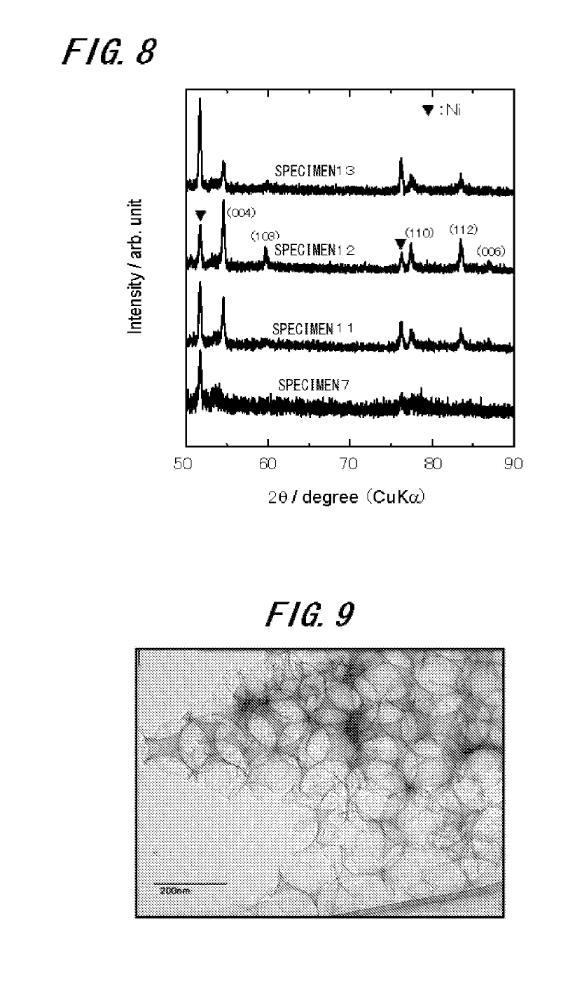

FIG. 3 is X-ray diffraction (XRD) patterns of the specimens 1, 2 and 3. FIG. 4 is X-ray diffraction patterns of the specimens 1, 4 and 5. FIG. 5 is X-ray diffraction patterns of the specimens 14 and 17. FIG. 6 is X-ray diffraction patterns of the specimens 6, 7, 8 and 19. FIG. 7 is X-ray diffraction patterns of the specimens 7 through 13. FIG. 8 is X-ray diffraction patterns of the specimens 7, 11, 12 and 13 at their high angle sides thereof.

Each of the X-ray diffraction patterns shown in FIGS. 3 through 6 is obtained by irradiating CuKc ray and analyzing a crystalline structure using Bragg-Brentano method in which a horizontal axis shows an angle formed by an incident X-ray of CuKc and a diffracted X-ray thereof and a vertical axis shows intensity of the diffracted X-ray (a scale is optional).

On FIG. 3, a catalyst-amount dependency in the execution examples 1 can be observed. All of the specimens 1, 2 and 3 can observe clear peaks of graphite phases but in the specimen 1 in which there is a small amount of catalyst, a broad peak caused by an amorphous phase is observed when comparing it with the specimens 2 and 3, which allows it to be said that the graphite phase and the amorphous phase are existed together. Thereby, it is found out that when a heat treatment temperature for graphitization is a low temperature of 900° C., the graphitization can be attained by increasing an amount of the catalyst only by desired amount thereof.

From FIG. 4, a heat treatment temperature dependency for the graphitization in the execution examples 1 can be observed. In all of the specimens 1, 4 and 5, clear peaks of graphite phases can be observed but in the specimen 1 in which the heat treatment temperature is low, a broad peak caused by an amorphous phase is observed when comparing it with the specimens 4 and 5, which allows it to be said that the graphite phase and the amorphous phase are existed together. Namely, it is found out that by performing a heat treatment at higher temperature, the amorphous phase disappears so that a greater part thereof is graphitized. Thus, if an amount of the catalyst is a low concentration of 3 mmol/g^{-C}, by raising the heat treatment temperature for graphitization, it is found out that the graphitization can be attained.

From FIGS. 3 and 4, it is found out that the amount of catalyst and the heat treatment temperature for graphitization can be suitably drawn from two relationships.

Further, as shown in FIG. 5, in also the specimen 14 of the execution example 2 in which any catalyst has been previously mixed into the carbon source, a peak derived from the graphite phase, which is broad, is seen. Thereby, it is found out that the graphitization can be attained at a low heat treatment temperature of about 900° C. also in a case where any catalyst has been previously mixed into the carbon source. On the other hand, in the specimen 18 of the comparison examples in which the heat treatment temperature is set to 1000° C. without using any catalyst, a broad peak indicating the amorphous phase is seen but any graphite phase is not seen. Thereby, it is found out that in a case where any catalyst is not used, at the heat treatment temperature of about 1000° C., the graphitization does not advance.

Further, as shown in FIG. 6, in all of the specimens 6, 7 and 8, clear peaks of graphite phases can be observed but in the specimen 19 in which any catalyst is not used, a broad peak indicating an amorphous phase can be confirmed but any peak indicating the graphite phase is not observed. Thereby, it is found out that even when using SiO₂ particles having mean particle size of 450 nm, by using a catalyst, the graphitization can be attained at a heat treatment temperature of about 1000° C. On the other hand, it is found out that, in the specimen 19 which is made without using any catalyst, the graphitization is not attained.

As described in the above, from X-ray diffraction patterns, in the execution examples 1 and 2 in each of which the catalyst is used, it is found out that the graphitization advances at the heat treatment temperature of 900° C. through 1500° C., which are lower than those of the conventional case.

Further, as shown in FIG. 7, in all of the specimens 7 through 13 in which SiO₂ opal composed of SiO₂ particles having mean particle size of 450 nm is used as the mold, and the heat treatment temperature for graphitization is within a range of 900° C. through 1500° C., clear peaks of graphite phases are seen.

Further, as shown in FIG. 8, when looking at peaks of X-ray diffraction of their high-angle sides, in the specimen 12 in which the graphitization is attained at the heat treatment temperature of 1400° C., high-order peaks of (004) surface, (103) surface and the like are more strongly observed, from which it has been found that the graphitization is particularly advanced.

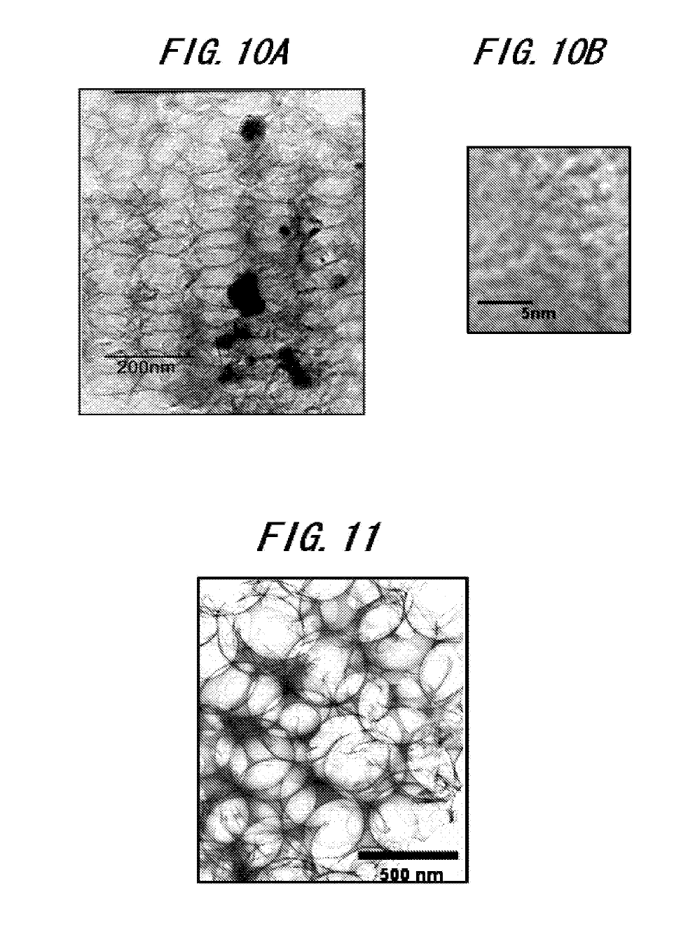

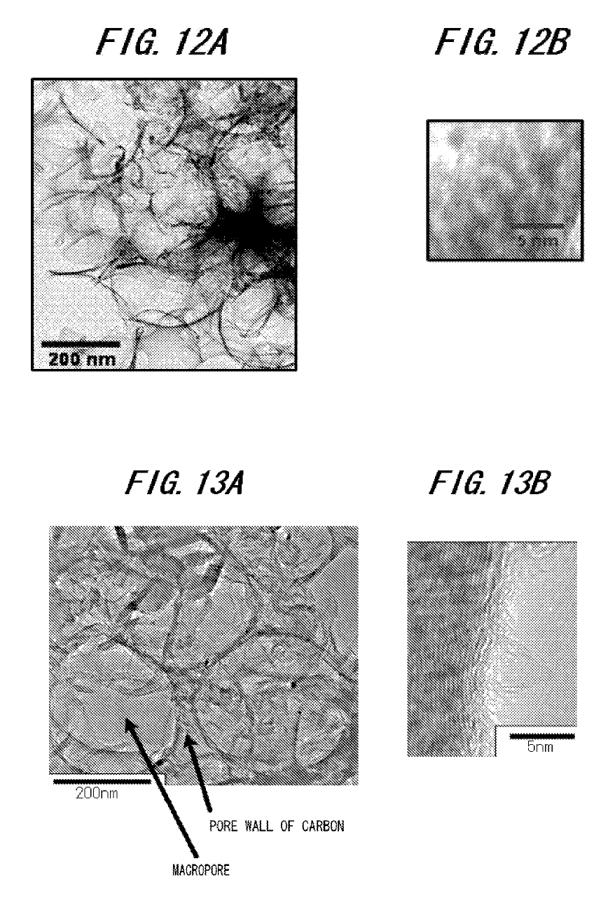

FIG. 9 is a transmission electron microscope (TEM) photograph of the specimen which is obtained by removing SiO₂ opal, which is a mold, after a heat treatment has been performed on a composite of phenol resin and SiO₂ opal composed of SiO₂ particles having mean particle size of 190 nm at a temperature of 400° C. when manufacturing the specimen 1 in the execution examples 1. Further, FIG. 10A is a TEM photograph of the specimen 4 made by carrying out the graphitization at a treatment temperature of 1000° C. and FIG. 10B is a TEM photograph in which a part of FIG. 10A (a part of pore wall) is enlarged.

From TEM photograph of FIG. 9, it can be confirmed that in the execution examples 1, porous structure is formed by pores which are formed by removing SiO₂ opal as the mold so as to have a diameter of 190 nm that is the same diameter as mean particle size of SiO₂ particles constituting SiO₂ opal.

From TEM photograph of FIG. 10A, it can be confirmed that, of the execution examples 1, in the specimen 4 formed by heating at the heat treatment temperature of 1000° C., porous structure in which macropores are three-dimensionally connected with each other is formed by macropores which are formed so as to have a diameter of about 130 through 180 nm. From FIG. 10B, it can be also confirmed that in the specimen 4, on the pore walls of the macropores thus formed, a graphite phase is formed. Here, the macropore is referred to as a pore having a diameter of not less than 50 nm.

FIG. 11 is a TEM photograph of the specimen which is obtained by removing SiO₂ opal, which is a mold, after a heat treatment has been performed on a composite of phenol resin and SiO₂ opal composed of SiO₂ particles having mean particle size of 450 nm at a temperature of 400° C. when manufacturing the specimen 6 using the execution examples 1. Further, FIG. 12A is a TEM photograph of the specimen 6 made by carrying out the graphitization at a treatment temperature of 1000° C. and FIG. 12B is a TEM photograph in which a part of FIG. 12A (a part of pore wall) is enlarged.

From TEM photograph of FIG. 11, it can be confirmed that when manufacturing the specimen 6 in the execution examples 1, porous structure is formed by pores which is formed by removing SiO₂ opal as the mold so as to have a diameter of 450 nm that is the same diameter as mean particle size of SiO₂ particles.

From TEM photograph of FIG. 12A, it can be also confirmed that in the specimen 6 formed by heating at the heat treatment temperature of 1000° C., porous structure in which macropores are three-dimensionally connected with each other is formed by macropores which are formed so as to have a diameter of about 300 through 380 nm. Further, from FIG. 12B, it can be also confirmed that in the specimen 6, on the pore walls of the macropores thus formed, a graphite phase is formed.

Further, FIG. 13A is a TEM photograph of the specimen 12 made by carrying out the graphitization at a treatment temperature of 1400° C. using as the mold SiO₂ particles having mean particle size of 450 nm and FIG. 13B is a TEM photograph in which a part of FIG. 13 (a part of pore wall) is enlarged.

From TEM photographs of FIGS. 13A and 13B, it can be also confirmed that even when using as a mold SiO₂ opal composed of SiO₂ particles having 450 nm, supporting the catalyst of 15 mmol/g−C and carrying out the graphitization at 1400° C., macroporous structure in which macropores are three-dimensionally connected with each other is formed and, on surfaces of the pore walls thereof, a graphite phase is formed. It is conceivable that on the surfaces of macropores of carbon, by a surface activity with the supported catalyst, the graphite phase is formed on the surfaces of macropores. In this case, it is also confirmed that the macroporous structure is formed by the macropores having a diameter of about 300 through 380 nm.

On the other hand, in the specimen 15 obtained in the comparison examples, it is confirmed that diameters of macro pores formed after the graphitization are within a range of 90 through 130 nm (an illustration thereof will be omitted).

Thus, it is seen that degree of shrinkage of the pores like the execution examples 1 using the catalyst is less than degree of shrinkage of the pores in a case of the comparison examples where the catalyst is not used.

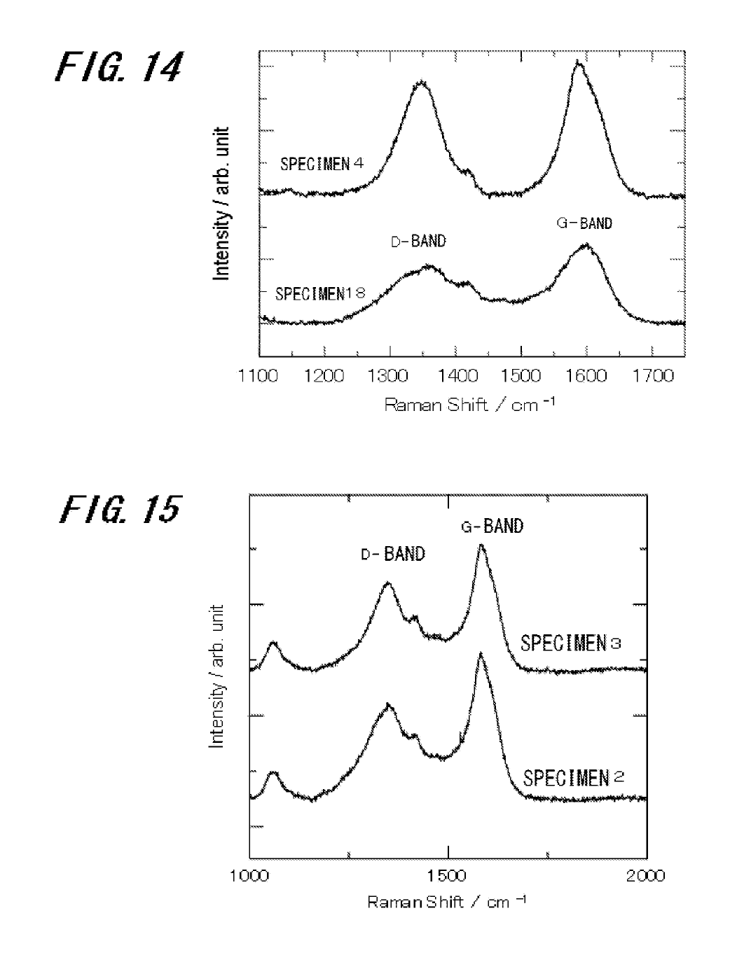

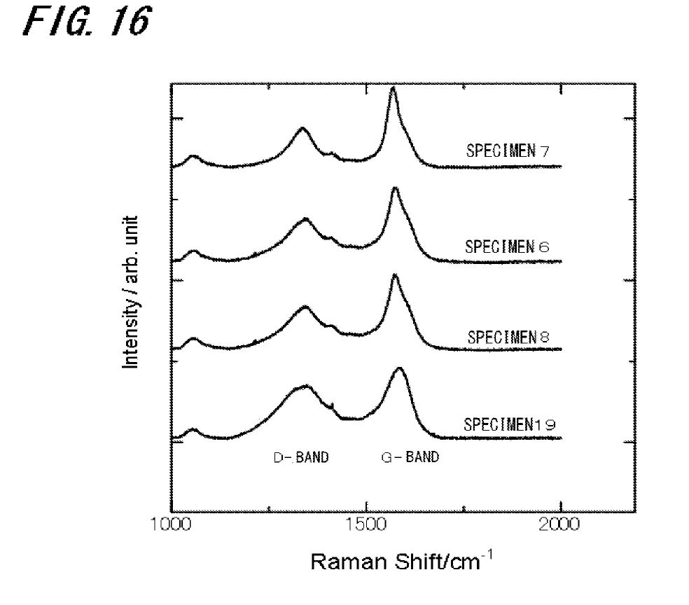

Next, FIG. 14 shows Raman spectra of the specimens 4 and 18. FIG. 15 also shows Raman spectra of the specimens 2 and 3. Further, FIG. 16 shows Raman spectra of the specimens 6, 7, 8 and 19. In each of FIGS. 14 through 16, a horizontal axis shows Raman shift (cm⁻¹) and a vertical axis shows intensity of Raman scattering (a scale is optional).

When the graphitization advances, the intensity of G band in Raman spectrum becomes strong. On the other hand, D band appears when decreasing crystalline capacity of graphite or when an amorphous phase exists. From FIGS. 14 and 15, it is seen that the specimens 2, 3 and 4 manufactured in the execution examples 1 have large intensities in G band and the graphitization advances. On the other

hand, as shown in FIG. 14, in the specimen 18 manufactured in the comparison examples, has a smaller intensity in G band than that of the specimen 4 manufactured in the execution examples 1, from which it is seen that the specimen 18 is less graphitized than the specimen 4.

Further, in FIG. 16, the specimens 6, 7 and 8 of the execution examples 1 have large intensities of G band and have smaller intensities of D band than those of G band. Therefrom, it is seen that in the specimens 6, 7 and 8, the graphitization advances and an amorphous phase exerts less influence thereon. On the other hand, the specimen 19 manufactured in the comparison examples has a smaller intensity of G band than that of each of the specimens 6, 7 and 8 and has a larger intensity of D band. Therefrom, it is seen that an amorphous phase exerts larger influence thereon.

Next, measurement results of total specific surface area, specific surface area of micropores, a ratio of specific surface area of the micropores in relation to the total specific surface area, area ratio of D band and G band obtained by Raman spectrum (D/G area ratio) and interlayer distance of hexagonal carbon network (d(002)) of the above-mentioned specimens of the execution examples 1 and 2 and the comparison examples are shown in a table 1.

TABLE 1

| | | | | | | | | Ratio of | | |
|---|---|---|---|---|---|---|---|---|---|---|
| | | | Diameter | Amount of | Heat Treatment | Total | Specific | Specific | | |
| | | | of SiO₂ | Catalyst | Temperature | Specific | Surface | Surface | Raman | |
| | | Carbon | Particles | (mmol/ | (Graphitization) | Surface | Area of | Area of | D/G Area | |
| | | Source | (nm) | g-C) | (° C.) | Area(m²g⁻¹) | Micropore | Micropore | Ratio | d(002) |
| Execution | Specimen 1 | Phenol Resin | 190 | 3 | 900 | 759 | 558 | 0.74 | 1.05 | Unclear Peak |
| Examples 1 | Specimen 2 | Phenol Resin | 190 | 9 | 900 | 461 | 246 | 0.53 | 0.91 | 0.345 |
| | Specimen 3 | Phenol Resin | 190 | 15 | 900 | 451 | 220 | 0.49 | 0.83 | 0.343 |
| | Specimen 4 | Phenol Resin | 190 | 3 | 1000 | 205 | 20 | 0.098 | 0.80 | 0.344 |
| | Specimen 5 | Phenol Resin | 190 | 3 | 1500 | 554 | 395 | 0.71 | 0.91 | 0.343 |
| | Specimen 6 | Phenol Resin | 450 | 3 | 1000 | 395 | 217 | 0.60 | 0.83 | 0.343 |
| | Specimen 7 | Phenol Resin | 450 | 15 | 1000 | 256 | 88 | 0.34 | 0.66 | 0.342 |
| | Specimen 8 | Phenol Resin | 450 | 15 | 900 | 287 | 136 | 0.47 | 0.63 | 0.343 |
| Execution | Specimen 14 | Phenol Resin | 190 | 3 | 900 | 1333 | 478 | 0.356 | 0.96 | Unclear Peak |
| Example 2 | | | | | | | | | | |
| Comparison | Specimen 15 | Pitch | 190 | 0 | 2500 | 174 | 5 | 0.03 | 0.56 | 0.343 |
| Examples | Specimen 16 | Pitch | 190 | 0 | — | 287 | 25 | 0.09 | 0.75 | No Peak |
| | Specimen 17 | Phenol Resin | 190 | 0 | — | 1120 | 940 | 0.84 | 1.50 | No Peak |
| | Specimen 18 | Phenol Resin | 190 | 0 | — | 1025 | 840 | 0.82 | 1.33 | No Peak |
| | Specimen 19 | Phenol Resin | 450 | 0 | | 841 | 740 | 0.88 | 1.52 | No Peak |

Further, measurement results of total specific surface area, Raman D/G area ratio, interlayer distance of hexagonal carbon network (d(002)) and diameter of crystallite of the specimens 8 through 13 manufactured in the above-mentioned execution examples 1 and the specimen 20 manufactured in the comparison example are shown in a table 2.

TABLE 2

| | | | Diameter | Amount of | Heat Treatment | Total | | | |
|---|---|---|---|---|---|---|---|---|---|
| | | | of SiO₂ | Catalyst | Temperature | Specific | Raman | | Diameter of |
| | | Carbon | Particles | (mmol/ | (Graphitization) | Surface | D/G Area | | Crystallite |
| | | Source | (nm) | g-C) | (° C.) | Area (m²g⁻¹) | Ratio | d(002) | (nm) |
| Execution | Specimen 7 | Phenol Resin | 450 | 15 | 1000 | 256 | 0.66 | 0.342 | 10.5 |
| Examples 1 | Specimen 8 | Phenol Resin | 450 | 15 | 900 | 287 | 0.63 | 0.343 | 11.2 |
| | Specimen 9 | Phenol Resin | 450 | 15 | 1100 | 183 | 0.50 | 0.343 | 10.2 |
| | Specimen 10 | Phenol Resin | 450 | 15 | 1200 | 152 | 0.59 | 0.337 | 13.8 |
| | Specimen 11 | Phenol Resin | 450 | 15 | 1300 | 107 | 0.48 | 0.337 | 23.6 |
| | Specimen 12 | Phenol Resin | 450 | 15 | 1400 | 69 | 0.44 | 0.337 | 29.3 |
| | Specimen 13 | Phenol Resin | 450 | 15 | 1500 | 109 | 0.51 | 0.337 | 24.6 |
| Comparison | Specimen 20 | Pitch | 450 | 0 | 2500 | 96 | 0.45 | 0.341 | 8.44 |
| Example | | | | | | | | | |

The micropore is referred to as a pore having a diameter of not more than 2 nm. The total specific surface area and the specific surface area of micropores are obtained from a nitrogen adsorption isotherm measured at 77K by using Brunauer-Emmett-Teller (BET) method. The D/G area ratio is measured from Raman spectra shown in FIGS. 14 through 16. The interlayer distance of hexagonal carbon network (d(002)) is calculated using Bragg's equation from an angle of diffraction peak (peak between 20 degrees and 30 degrees in 2θ) in X-ray diffraction pattern, which corresponds to an interlayer distance of graphite phases.

As shown in the Table 1, the ratios of specific surface area of micropores in relation to the total specific surface area in the specimens 1 through 8 and 14 manufactured in the execution examples 1 and 2 show not less than 0 and not more than 0.74, which are smaller than those of the specimens manufactured in the comparison examples at a heat treatment temperature of 1000° C. or less. When the graphitization advances, a ratio of the micropores decreases so that it is seen that in the specimens 1 through 8, the graphitization suitably advances. It is to be noted that the specimens 9 through 13 do not show any specific surface area of the micropores, but as seen from the X-ray diffraction patterns shown in FIGS. 3 through 8, when using a mold composed of particles having mean particle size of 450 nm, the ratio of specific surface area of the micropores fully satisfies not less than 0 and not more than 0.74 because the graphitization advances even when using a mold composed of particles having mean particle size of 190 nm.

Further, from Tables 1 and 2, in the specimens 1 through 14 manufactured in the execution examples 1 and 2, an area ratio of D band and G band (D/G area ratio) in Raman spectrum indicating the graphite phase has a value of not less than 0 and not more than 1.33. Further, as described above, an advance degree of graphitization can be seen even using D/G area ratio but it is seen that in all of the specimens 1 through 14, the area ratio shows a value of not less than 0 and not more than 1.33, which indicates that the graphitization is suitably performed.

Thus, from every data, it is seen that the specimens 1 through 14 in the execution examples 1 and 2 form the graphite phases more satisfactorily than the comparison examples 1 and 2.

Next, charge-discharge behaviors of the specimens manufactured in the execution examples 1 and 2 and the comparison examples were measured using a three electrode cell composed of a working electrode, a reference electrode, an auxiliary electrode and nonaqueous electrolyte. The working electrode was made by mixing binder composed of polytetrafluoroethylene (PTFE) to each specimen at 10 wt % and pressing it onto a nickel mesh. The reference electrode and the auxiliary electrode were made by pressing metallic lithium onto nickle meshes. As the nonaqueous electrolyte, the one in which electrolyte, LiPF₆ of one mol is dissolved into a mixed solvent of ethylene carbonate (EC) and dimethyl carbonate (DMC) (1:1 v/v) was used.

In this three electrode cell, the charge and discharge were measured at a desired constant current density [mA/g] within an electric potential range of 0 V through 3 V (vs. Li/Li⁺). The results thereof are shown in FIGS. 17 through 24.

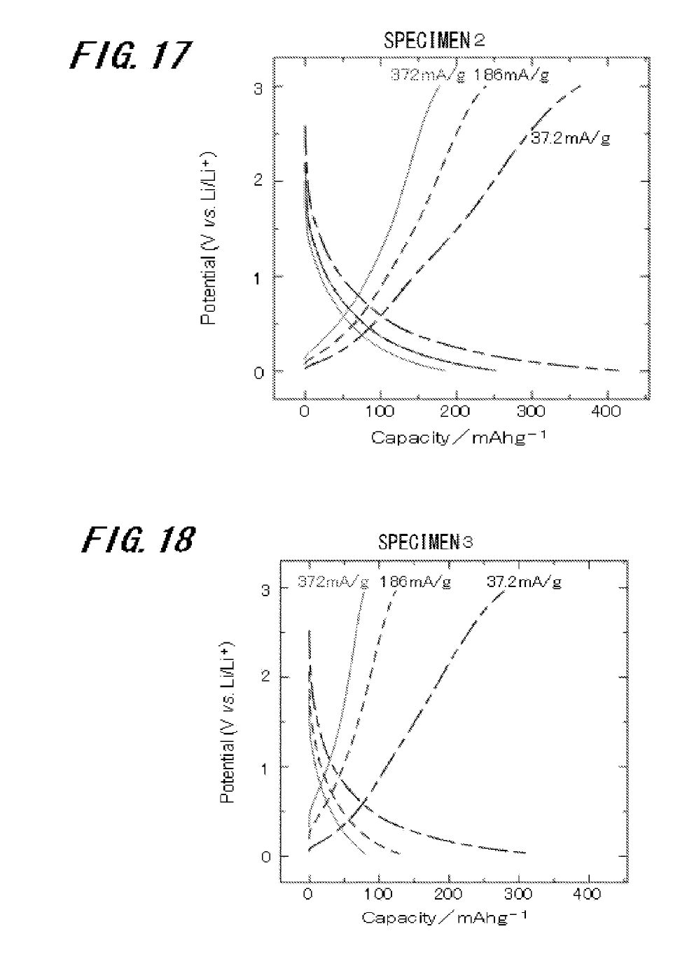

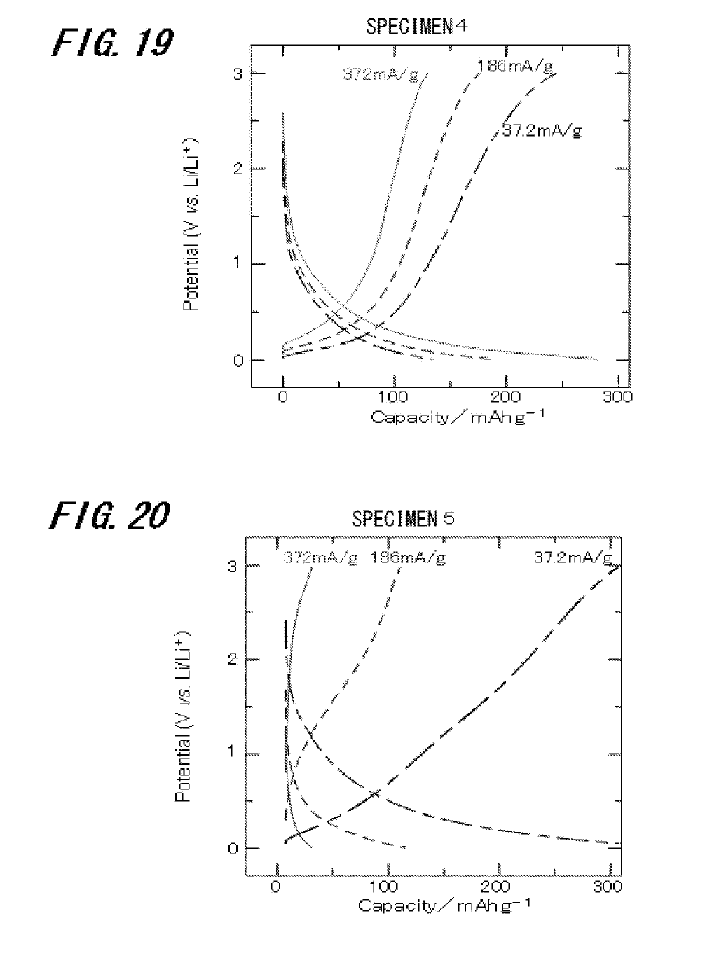

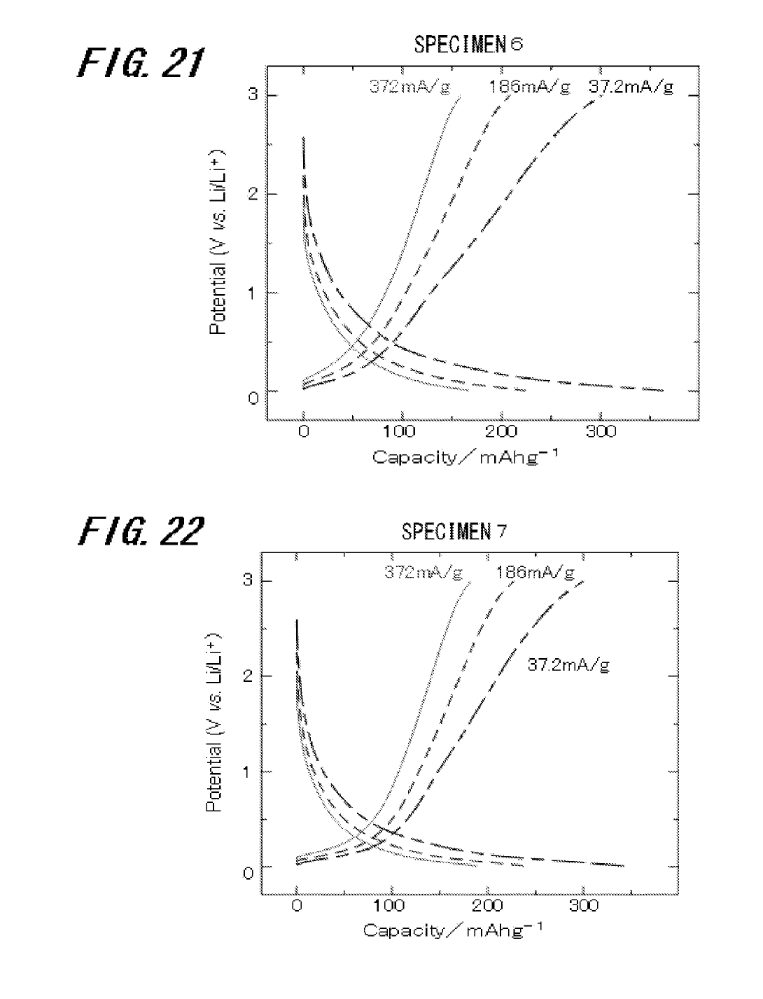

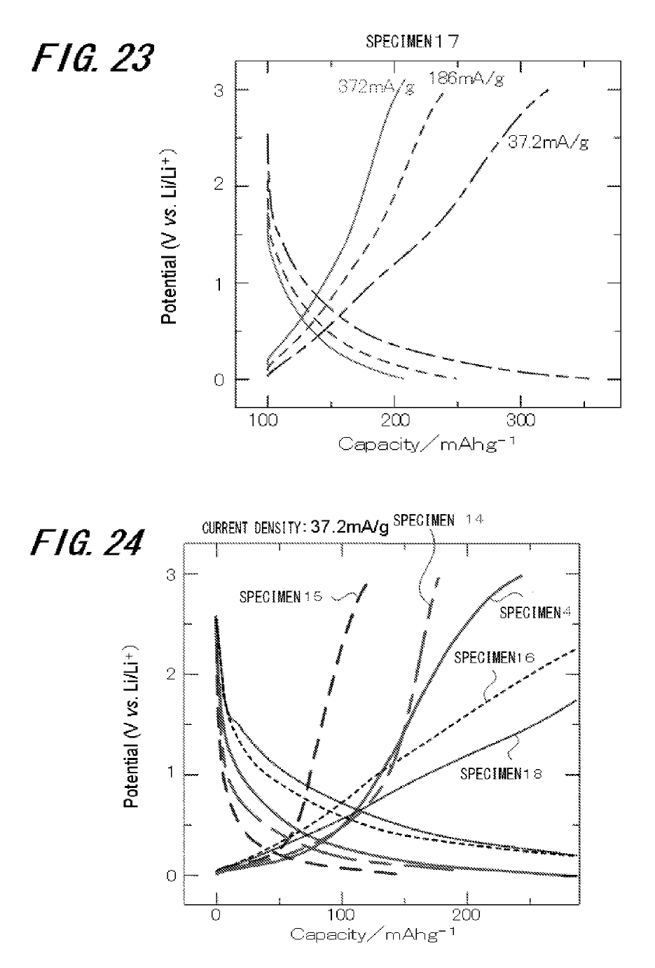

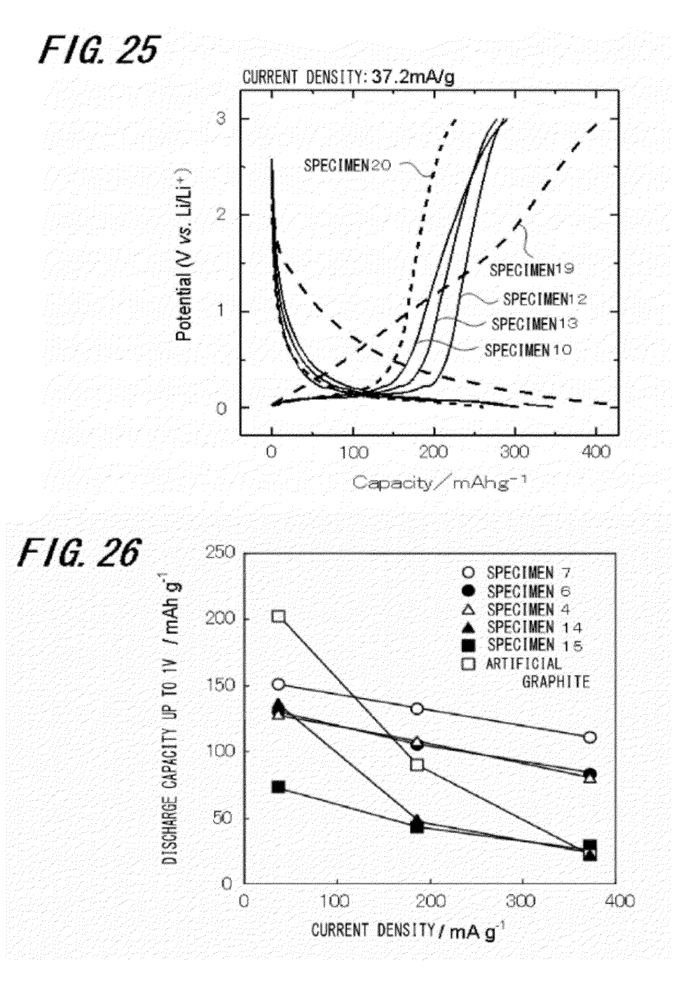

FIG. 17 is a diagram showing charge and discharge curves of the specimen 2 made in the execution examples 1. FIG. 18 is a diagram showing charge and discharge curves of the specimen 3 made in the execution examples 1. FIG. 19 is a diagram showing charge and discharge curves of the specimen 4 made in the execution examples 1. FIG. 20 is a diagram showing charge and discharge curves of the specimen 5 made in the execution examples 1. FIG. 21 is a diagram showing charge and discharge curves of the specimen 6 made in the execution examples 1. FIG. 22 is a diagram showing charge and discharge curves of the specimen 7 made in the execution examples 1. FIG. 23 is a diagram showing charge and discharge curves of the specimen 17 made in the comparison examples. FIG. 24 is also a diagram showing charge and discharge curves of the specimens 4, 14, 15, 16 and 18 on current density of 37.2 mA/g. Further, FIG. 25 is a diagram showing charge and discharge curves of the specimens 10, 12, 13, 19 and 20 on current density of 37.2 mA/g. A horizontal axis of each of the FIGS. 17 through 25 shows charge and discharge capacity per unit time and a vertical axis thereof shows discharged potential (V vs. Li/Li+). Curves in which potentials increase in a direction where capacities increase are discharge curves and the reverse ones thereof are charge curves.

By using FIGS. 19 and 20, charge-discharge behaviors of the specimens 4 and 5 manufactured in the execution examples 1 will be compared. In the specimens 4 and 5, clear peaks of the graphite phases have been confirmed in both from X-ray diffraction patterns shown in FIG. 4 but in the charge and discharge curves of the specimen 4 shown in FIG. 19, flat portions are shown below 0.3 V in the discharge curves while in those of the specimen 5 shown in FIG. 20, any flat portions are not clearly shown below 0.3 V in the discharge curves. Further, as shown in FIG. 20, in the specimen 5, when the current density increases, the capacity decreases. Therefore, in the execution examples 1, it is conceivable that the heat treatment temperature suitable for the graphitization is within a range of 1500° C. or below. Since when increasing an amount of catalyst, the graphitization can be satisfied at even 900° C. from a result of the above-mentioned X-ray diffraction patterns, it is preferable to set the heat treatment temperature within a range of not less than 900° C. and not more than 1500° C. It is also more suitable to set the heat treatment temperature to about 1000° C.

By using FIGS. 17, 18 and 23, charge-discharge behaviors of the specimens 2, 3 and 17 will be compared.

When comparing the charge and discharge curves shown in FIGS. 17, 18 and 23, in the specimens 2 and 3 manufactured in the execution examples 1, capacities of the discharge curves in 0.3 V or below increase, compared with the specimen 17 manufactured in the comparison examples, so that a contribution of intercalation or deintercalation of the lithium ions into or from the graphite phase is recognized. In the specimens 2 and 3, clear peaks of the graphite phases have been confirmed in both from the X-ray diffraction patterns shown in FIG. 3 but in the charge-discharge behaviors, it is seen that the specimen 2 has better rate performances than those of the specimen 3. Thus, a suitable amount of the catalyst is considered so as to be 15 mmol/g^{-c} or below. From a result of the X-ray diffraction patterns, it is known that if the heat treatment temperature for the graphitization is 900° C., the peaks of amorphous phases also become large when an amount of the catalyst is 3 mmol/g^{-c}. Thus, it is preferable that the amount of catalyst is within a range of not less than 3 mmol/g^{-c} and not more than 15 mmol/g^{-c}.

By using FIGS. 21 and 22, charge-discharge behaviors of the specimens 6 and 7 manufactured in the execution examples 1 will be compared. When comparing FIGS. 21 and 22, in a case of using SiO₂ opal composed of SiO₂ particles having mean particle size of 450 nm as the mold, the specimen 7 using the catalyst of 15 mmol/g^{-c} has larger flat portions of low potential in the discharge curves than those of the specimen 6 using the catalyst of 3 mmol/g^{-c} and also has larger capacities. This is because the specimen 7 has smaller D/G area ratio than that of the specimen 6 so that the graphitization advances in it more than the specimen 6.

By using FIG. 24, the specimens manufactured in the execution examples 1 and 2 and the comparison examples will be compared. When using SiO₂ particles having mean particle size of 190 nm as mold particles, the specimens 16 and 18 made at the heat treatment temperature of 1000° C. without using any catalyst have no flat portion in the discharge curves near 0.2 through 0.3 V and their potentials alter largely together with the discharge. On the other hand, in the specimen 4 manufactured in the execution examples 1 and the specimen 4 manufactured in the execution example 2, flat portions below 0.3 V based on the intercalation or deintercalation of lithium ions into or from the graphite phase are seen in both specimens.

When using it as negative electrode materials of lithium-ion secondary battery, in order to maintain high electromotive force, it is preferable to discharge electricity at a constant low electric potential. Because of this, when using the specimens 4 and 14 having flat portions in the discharge curves below 0.3 V as the negative electrode materials of the lithium-ion secondary battery, a lithium-ion secondary battery having good charge-discharge behaviors is obtained. However, the specimens 16 and 18 in which any graphitization is carried out are unsuitable for the negative electrode materials of the lithium-ion secondary battery.

When using SiO₂ particles having the same size as the mold particles, it is seen that the specimen 4 manufactured at a low heat treatment temperature of 1000° C. using the catalyst has larger charge-discharge capacity than that of the specimen 15 manufactured from pitch at a high heat treatment temperature of 2500° C.

By using FIG. 25, the specimens 10, 12, 13, 19 and 20 in which SiO₂ opal composed of SiO₂ particles having mean particle size of 450 nm as the mold will be compared. As comparing a curve of the specimen 20 without supporting any catalyst, in the specimens of 15 mmol/g^{-C}, plateau regions appear at low electric potential sides (not more than 0.3 V) and when the heat treatment temperature increases, it is seen that the plateau region enlarges and the capacity increases. However, in the specimen 13 in which the graphitization is carried out at the heat treatment temperature of 1500° C. which excesses 1400° C., the capacity decreases, so that it is considered that the heat treatment temperature for the graphitization of 1400° C. is optimal, which agrees with a result of the X-ray diffraction shown in FIG. 8.

Further, it is known that a reaction of intercalation or deintercalation of the lithium ions into or from the graphite phase shows charge and discharge curves like the plateau depending on intercalation stage of Li below 0.3 V. From FIG. 25, it is clearly observed that the specimens 10, 12 and 13 manufactured in the execution examples 1 have the plateaus below 0.3 V. In, also, the specimen 20 in which pitch materials are graphitized at the heat treatment temperature of 2500° C., charge and discharge curves having similar formation are observed but its capacity is smaller than that of the specimen supporting the catalyst and heated at 1200° C. or higher. Since the specimen 19 without supporting any catalyst is not graphitized, no plateau region at a low electric potential show and its electric potential alters largely when charging or discharging it so that when using it as negative electrode materials of a battery, any stable electromotive force cannot be obtained and an energy density thereof decreases when discharging electricity. Therefore, it is unsuitable for battery materials which are desirable for a constant high electromotive force or energy density.

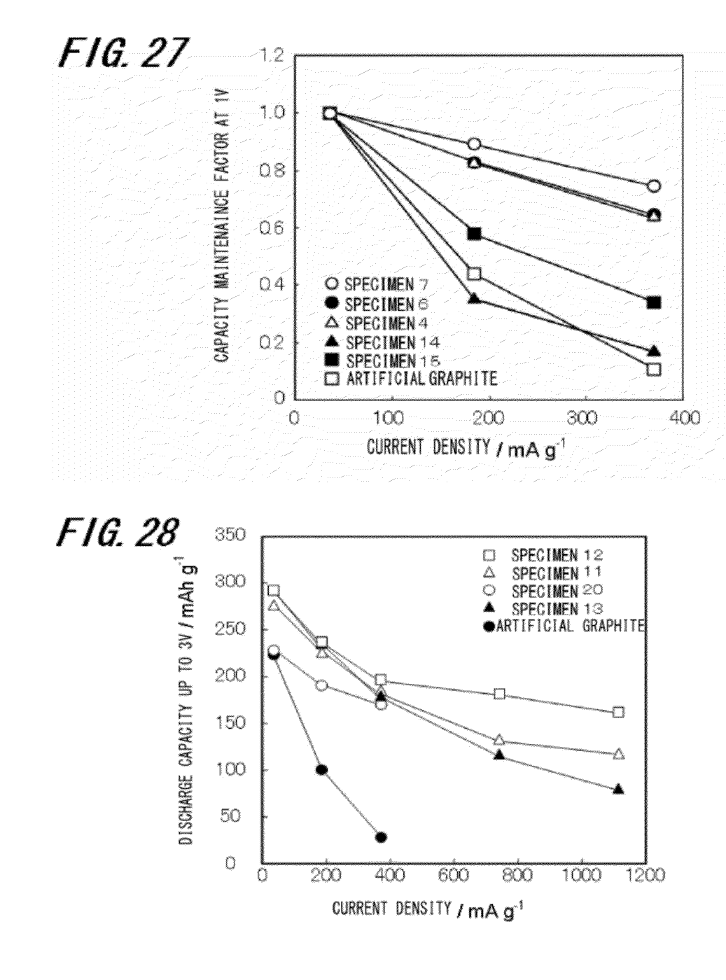

Next, FIGS. 26 and 27 show rate performances of the specimens 4, 6, 7, 14 and 15 and artificial graphite. A horizontal axis of FIG. 26 shows current density (mAg⁻¹) and a vertical axis thereof shows a discharge capacity up to 1V (mAhg⁻¹). A horizontal axis of FIG. 27 also shows current density and a vertical axis thereof shows a capacity maintenance factor at 1V, which is a value in which a capacity of current density of 37.21 mAg⁻¹ is normalized as 1.

As seen from FIG. 26, the specimens 4, 6, 7 and 14 in the execution examples 1 and 2 have higher discharge capacities than that of the specimen 15 of the comparison examples. Their capacities at the current density of 37.21 mAg⁻¹ are higher than a capacity, 74 mAhg⁻¹, of the specimen 15. Nevertheless the specimen 15 has the ratio of specific surface area of micropores and D/G area ratio which are similar to those of the execution examples 1 and 2 in the Table 1, it is seen that a value of its capacity is small. This is because the total specific surface area is considered so as to be small, 174 m²g⁻¹.

Further, as seen from FIG. 27, the specimens 4, 6, 7 and 14 in the execution examples 1 and 2 have higher capacity maintenance factor than those of the specimen 15 of the comparison examples and a graphite and good discharge rate, which has an excellent discharge rate and a fast charge-discharge behavior.

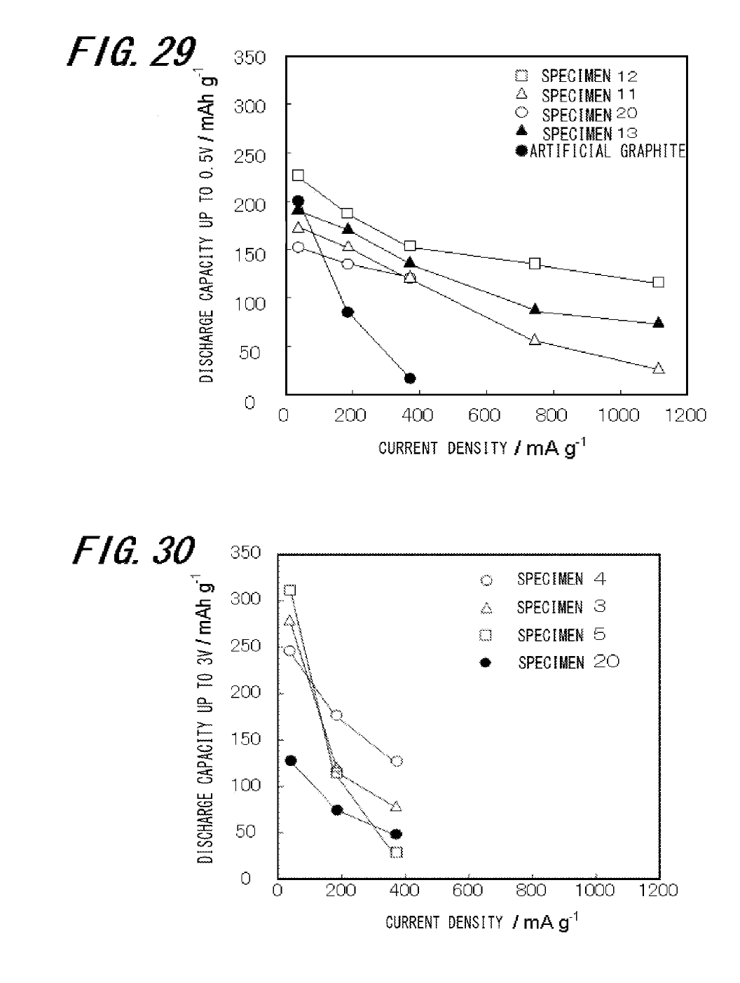

Next, FIGS. 28 and 29 show rate performances of the specimens 11, 12, 13 and 20 and artificial graphite. A horizontal axis of FIG. 28 shows current density (mAg⁻¹) and a vertical axis thereof shows a discharge capacity up to 3V (mAhg⁻¹). A horizontal axis of FIG. 29 also shows current density and a vertical axis thereof shows a discharge capacity up to 0.5 V.

When using SiO₂ opal composed of SiO₂ particles having mean particle size of 450 nm as the mold, particularly, the specimens 12 and 13 which are graphitized at the heat treatment temperature of 1400° C. maintain high capacities up to high current density in both regions of 0 through 3 V and 0 through 0.5 V. In the artificial graphite, when the current density increases, its capacity suddenly decreases but it is superior to the specimen 20 in a fast charge-discharge behavior.

Next, FIGS. 30 and 31 shows rate performances of the specimens 3, 4, 5 and 20. A horizontal axis of FIG. 30 shows current density (mAg⁻¹) and a vertical axis thereof shows a discharge capacity up to 3V (mAhg⁻¹). A horizontal axis of FIG. 31 also shows current density and a vertical axis thereof shows a discharge capacity up to 0.5 V.

As seen from FIG. 30, when using SiO₂ opal composed of SiO₂ particles having mean particle size of 190 nm as the mold, discharge capacity from 0 to 3 V is large. However, when comparing FIG. 31 with FIG. 29, the discharge capacity of the specimens obtained by using the mold composed of particles having 190 nm from 0 up to 0.5 V (see FIG. 31) is smaller than the discharge capacity of the specimens obtained by using the mold composed of particles having 450 nm (see FIG. 29). Further, as seen from FIGS. 30 and 31, when using the mold composed of particles having 190 nm, capacity decreases in higher current density. As seen from the comparisons of FIGS. 3, 4 and 8 described above, the griphitization is superior to advance in the specimens in which the mold composed of particles having mean particle size of 450 nm is used and large pore sizes are formed. Namely, it is conceivable that if the pore sizes are small, the graphitization is poor, so that the discharge capacity in low electric potentials is small.

Further, from FIGS. 13A and 13B, it is seen that when using the mold composed of particles having mean particle size of 450 nm, any graphitization is not performed up to inside of the pore wall and a graphite phase is preferentially formed on a pore surface. When a pore size is larger, a thickness of wall is thicker so that if a graphite phase is formed on a pore surface similarly, a ratio of weight of the graphite phase in relation to total weight thereof rather becomes smaller when the pore size is larger. Namely, it is possible to estimate that charge-discharge capacity per unit weight rather deceases. Therefore, it is conceivable that any materials having higher performance are hard to be expected even if the similar synthesis is carried out from porous carbon having a pore size more than 450 nm with a catalyst being supported.

Thus, in this invention, it is conceivable that an upper limit of mean particle size of SiO₂ particles constituting the mold is 450 nm.

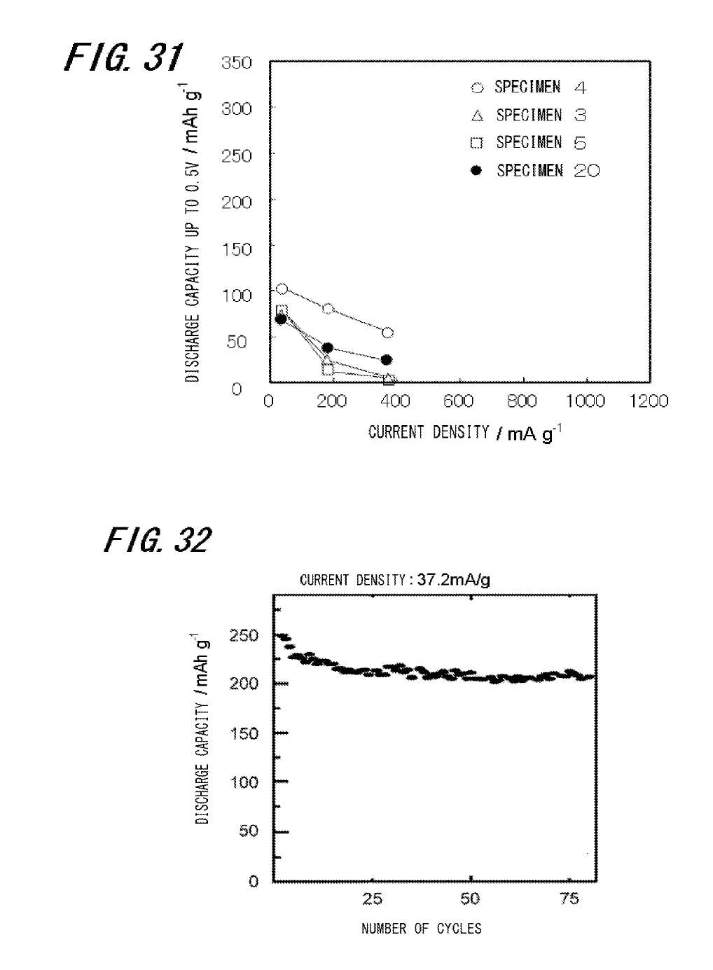

FIG. 32 is a diagram showing cycle life characteristic of the specimen 11 made in the execution examples. A horizontal axis of FIG. 32 shows a number of cycles (a number of measured times) and a vertical axis thereof shows a discharge capacity (mAhg⁻¹) on current density of 37.2 mA/g. As shown in FIG. 32, in the measurement up to 75 cycles, the discharge capacity is stably maintained. It is thus seen that even if utilization thereof as negative electrode materials of battery is repeated at plural times, stable performance can be obtained.

From the above-mentioned execution examples 1 and 2, it is seen that the macroporous graphite electrode materials according to this embodiment have a higher charge-discharge capacity in a high current density than that of the conventional graphite electrode materials and is superior to that in a fast charge-discharge behavior.

In the high performance of graphite materials, a development in which by making specific surface area low, a reversibility of charge and discharge is made higher has been previously carried out. In this embodiment, however, high performance of the materials having high specific surface area is realized. This enables fast charge-discharge to be realized. Further, hard carbon materials such as phenol resin cannot be previously graphitized even if any heat treatment is performed thereon in high temperature, but in this embodiment, even if it is a carbon materials composed of phenol resin, the graphitization can be realized at a heat treatment temperature of not more than 1500° C., which enables any energy for manufacture to be reduced.

### 2. Second Embodiment

### Lithium-Ion Secondary Battery

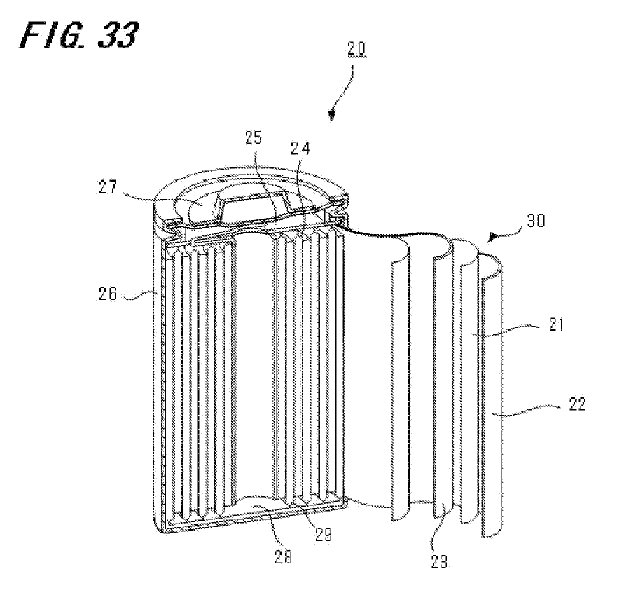

FIG. 33 shows an outline configuration of a lithium-ion secondary battery according to a second embodiment of this invention. The lithium-ion secondary battery 20 according to this embodiment is a case where nano composite porous electrode materials according to the first embodiment are used as positive electrode active materials.

The lithium-ion secondary battery 20 according to this embodiment is constituted of a cylindrical container 26 composed of nickel, a rolled-up body 30 contained in the container 26 and nonaqueous electrolyte which is similarly contained the container 26. A positive terminal 27 is formed on an upper bottom portion of the container 26. Further, a negative terminal, not shown, is formed on a lower bottom portion of the container 26.

The rolled-up body 30 is configured so as to wind a laminated body like a roll in which a band-like positive electrode element 22, a separator 21, a negative electrode element 23 are laminated in order. The positive electrode element 22 is configured so as to press mixed materials of positive electrode active materials composed of a lithium-transition metal complex compound which can absorb or discharge lithium ions reversibly, a conducting agent and a binder to a metallic foil composed of, for example, aluminum. The negative electrode element 23 is configured so as to press mixed materials of negative electrode active material composed of the above-mentioned macroporous graphite electrode materials according to the first embodiment, a conducting agent and a binder to a metallic foil composed of, for example, copper. Further, the separator 21 can use any conventionally used materials and is configured by, for example, high-polymer film such as polypropylene.

In the rolled-up body 30, the positive electrode element 22 and the negative electrode element 23 are electrically separated by the separator 21.

As the nonaqueous electrolyte, any conventionally used materials can be used and a mixed solution in which lithium hexafluorophosphate (LiPF₆) is dissolved as lithium salt into an organic solvent such as ethylene carbonate (EC) can be used. The nonaqueous electrolyte is impregnated in the container.

The positive electrode element 22 is then connected to a positive electrode tab connector 25 which is formed on the upper bottom of the container 26 by a lead wire 24 and this positive electrode tab connector 25 is electrically connected to the positive terminal 27 which is formed on the upper bottom of the container 26. The negative electrode element 23 is then connected to a negative electrode tab connector 28 which is formed on the lower bottom of the container 26 by a lead wire 29 and this negative electrode tab connector 28 is electrically connected to the negative terminal which is formed on the lower bottom of the container 26.

According to this embodiment, it is possible to obtain a high-performance lithium-ion secondary battery 20 which has a large charge-discharge capacity and can be rapidly charged or discharged because the above-mentioned macroporous graphite electrode materials according to this invention can be used as the negative electrode active materials.

### DESCRIPTION OF CODES

1 . . . SiO₂ Opal; 2 . . . Carbon Source; 3 . . . Composite; 4 . . . Composite; 5 . . . Macroporous Carbon; 6 . . . Pores; 7 . . . Nickel Nitrate; 8 . . . Graphited porous carbon; 9 . . . Macroporous Graphite Electrode Material; 10 . . . SiO₂ Opal; 11 . . . Carbon Source;
12 . . . Composite; 13 . . . Composite; 14 . . . Macroporous Graphite Electrode Material; 15 . . . Pores; 20 . . . Lithium-ion Secondary Battery; 21 . . . Separator; 22 . . . Positive Electrode Element; 23 . . . Negative electrode Element; 24 . . . Lead Wire; 25 . . . Positive Electrode Tab Connector; 26 . . . Container; 27 . . . Positive Terminal; 28 . . . Negative Electrode Tab Connector; 29 . . . Lead Wire; and 30 . . . Rolled-up body

1-12. (canceled)

13. A macroporous graphite electrode material that is graphitized at a heat treatment temperature of 1500° C. or less and is macroporous material in which the macropores have a porous structure in which macropores are three-dimensionally connected to each other and walls of the macropores are composed of graphitized carbon, wherein a ratio of specific surface area of micropores in relation to total specific surface area is not less than 0 and not more than 0.74 and a ratio of D band area and G band area in Raman spectrum (D/G area ratio) is not less than 0 and not more than 1.33.

14. The macroporous graphite electrode material according to claim 13, wherein the total specific surface area is 69 m²g⁻¹ or more.

15. The macroporous graphite electrode material according to claim 14, wherein a discharge capacity at a range of 0V through 1V (vs Li/Li⁺) in current density of 37.2 mA/g has a value of 74 mAh/g or more.

16. A manufacturing method of a macroporous graphite electrode material, comprising:
a step of preparing a mold made of SiO₂ particles;
a step of mingling the mold with a solution for carbon source;
a step of removing a solvent or the like from the solution for carbon source, resinifying the carbon source to form a composite of a carbon precursor resin and the mold;
a step of removing the mold therefrom to form macroporous carbon;
a step of supporting catalyst on the macroporous carbon; and
a step of forming a macroporous graphite by performing a heat treatment on the macroporous carbon supporting the catalyst at a temperature of not less than 900° C. and not more than 1500° C. so as to be graphitized.

17. The manufacturing method of the macroporous graphite electrode material according to claim 16, wherein the catalyst of 3 mmol or more and 15 mmol or less is added in relation to the macroporous carbon of one gram.

18. The manufacturing method of the macroporous graphite electrode material according to claim 17, wherein the particles of which the mold is composed have mean particle size of not less than 100 nm and not more than 450 nm.

19. A manufacturing method of a macroporous graphite electrode material comprising:
a step of preparing a mold made of SiO₂ particles;
a step of preparing a carbon source solution into which a catalyst is added;
a step of mingling the mold with a solution for carbon source;
a step of removing a solvent or the like from the solution for carbon source, resinifying the carbon source to form a composite of a carbon precursor resin and the mold;
a step of forming a composite of a graphite and the mold by performing a heat treatment on the composite of the carbon precursor resin and the mold at a heat treatment temperature of not less than 900° C. and not more than 1500° C. so as to be graphitized; and
a step of removing the mold and the catalyst from the composite of the graphite and the mold.

20. The manufacturing method of the macroporous graphite electrode material according to claim 19, wherein the catalyst of 3 mmol or more and 15 mmol or less is added in relation to the carbon, obtained after the carbon precursor resin has been carbonized, of one gram.

21. The manufacturing method of the macroporous graphite electrode material according to claim 19, wherein the SiO₂ particles have mean particle size of not less than 100 nm and not more than 450 nm.

22. A lithium-ion secondary battery comprising:
a positive electrode element having as positive electrode active material a lithium-transition metal composite compound into or from which lithium ions are reversibly intercalated or deintercalated;
a negative electrode element that is graphitized at a heat treatment temperature of 1500° C. or less and is macroporous material in which the macropores have a porous structure in which macropores are three-dimensionally connected to each other and walls of the macropores are composed of graphitized carbon, wherein a ratio of specific surface area of micropores in relation to total specific surface area is not less than 0 and not more than 0.74 and a ratio of D band area and G band area in Raman spectrum (D/G area ratio) is not less than 0 and not more than 1.33, the negative electrode element containing a negative electrode active material which intercalates or deintercalates the lithium ions at lower electric potential than that of the positive electrode active material; and
nonaqueous electrolyte in which lithium salt is dissolved in a nonaqueous solvent solution.

23. The lithium-ion secondary battery according to claim 22 wherein the total specific surface area is 69 m²g⁻¹ or more.

24. The lithium-ion secondary battery according to claim 23 wherein a discharge capacity at a range of 0V through 1V (vs Li/Li⁺) in current density of 37.2 mA/g has a value of 74 mAh/g or more.
